(19) United States
(12) Patent Application Publication
(10) Pub. No.: US 2007/0288073 A1
(43) Pub. Date: Dec. 13, 2007

(54) Single Apparatus for Photodynamic Energized Water

(76) Inventor: Iku Kuo, Thaipao City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/734,892

(22) Filed: Apr. 13, 2007

(30) Foreign Application Priority Data
May 26, 2006 (TW) 095118688

(51) Int. Cl. C02F 1/32

(52) U.S. Cl. 607/88; 356/300

(57) ABSTRACT

This invention relates to an apparatus for photodynamic energized water and, in particular, to a light emitting device and a container under the device. The light emitting device is made up of one or multiple spectrums of light emitters capable of emitting at different wavelengths thus allowing the light emitting device to shine onto the water in the container and causing the water to absorb the emitted light energy. The absorbed energy causes the individual water molecules to conform to a previously controlled energy level so that once consumed, the water is absorbed by cells of organs with corresponding resonant frequency and thus being able to mediate the cellular wavelengths by acting either destructively or constructively and allowing the cell activity to increase and subsequently improve the body's health and achieve immunity functions.

### FIELD OF THE INVENTION

The present invention relates to an apparatus for photodynamic energized water utilizes a light emitter capable of emitting at multiple wavelengths for a controlled period of time on drinking water allowing the water to absorb the photons to determined wavelength energy.

### DESCRIPTION OF THE RELATED ACT

Prior art of U.S. Pat. No. 575,443 disclosed a wavelength therapy apparatus involves the methodology for wavelength therapy as well as its corresponding setup as it pertains to different disease categories. Using a frequency controlling apparatus to isolate the recurring frequency measured in the wavelength therapy apparatus, frequencies are chosen according to the lowest frequency to highest frequency under controlled time. The frequency relating to electrode therapy or unrelated to such therapy, or to oscillating electromagnetic waves, or from resonant frequencies can be applied to the human body either individually or simultaneously, and those wavelengths corresponding to diseased areas of the human body can be isolated and utilized for therapy.

Also, while difference diseases will respond to a different degree of low frequency, compared to “normal” cells, the dysfunctional cells will be more susceptible to the lower frequency thus allowing the lower frequency wavelengths to pass more easily through the body parts affected by the disease. Thus, by beginning with the lowest frequency and progressively increasing it, one can rank the degree of seriousness of the diseased body part and thus begin treatment accordingly. By using a lower frequency and progressively increasing the frequency to stimulate the cells will cause the cell to regain its cellular activity and thus be able to treat the disease or at least move towards the direction of treatment.

However, the above described methodology comes from an external source being directed into the human body, similar to an extracellular infiltration of the intracellular space, and is a therapy relying on the external treating the internal.

For example, if there is a cut on our body, by cleaning the area and preventing external bacteria or germs from affecting it, our cells will reproduce and repair the cut itself. However, once the cut becomes infected and bacteria have entered the body, cleansing and preventative measures done externally are no longer adequate to aid the cells in repairing the cut. The cut may deteriorate, etc., and the patient will need both disinfectants as well as antibiotics in order to prevent further infection.

At the same time, the body is comprised of a set biological frequency. It has been scientifically proven that the biological frequency is between 3 to 45 nm, and according to the English physicist Frolich's Resonance Theory, when somatic cells come in contact with frequencies similar to itself, it will absorb the incoming frequency so that when this external frequency constructively interferes with the cellular frequency, heat is produced and increases circulation as well as cellular metabolism, For example, rehab water therapy, or spas rely on the principle that 70% of the human body is comprised of water which is at the same frequency as the surrounding water thus producing a constructive effect.

Also, the human body is a complex and intricate interaction of energies that reflects the physics and cellular composition of the body. The different “energies” in the body aids in the balance of hormones, electric physiology, and cellular function. This balance of energy is easily affected by one's environment, diet, emotional and psychological state, and directly related to the normal or abnormal growth of cells within the body. At the same time, each cell's ability to function both individually as well as collectively is dependent on the microscopic bioelectricity, especially the nervous system which is completely dependent on neurons and biochemistry to maintain its functions. The biochemistry is in turn dependent on electromagnetic waves. A normal person's body is made up of biological energy at less than 70 mV, and any energy operating at greater than 100 mV is harmful to the human body, especially when the body is at rest and cells are especially sensitive. If cells are affected at this time, not only are the cells unable to recover from the damage suffered during the day, the disturbance may cause it to react incorrectly, and with time (between 6 months to a few years), if no balance to the problem is achieved, the cells may mutate. In addition, the electromagnetic strength allowed by a resting cell is between 5-10 mV and 30 nT (nano Tesla) while most of our bedrooms often reveal 1,000+ mV electric field and 500 nT+ magnetic field causing the cells of our nervous system to constantly be in a resistant mode. This strong electromagnetic field can be caused by the sun's UV rays as well as different electrical and wireless devices. Studies from the United States and Switzerland have also shown that is the body is exposed to a magnetic field greater than 80 nT, the likelihood of getting leukemia is increased by three times, the harmful radiation suffered during sleep or in working environments are likely causes of the following illnesses: dysfunction of the immune system, allergies, sleeping problems, insomnia, various pains, depression, stress, tinnitus, organ failure, cancer, etc.

### SUMMARY OF THE INVENTION

As explained above, an external treatment may be able to achieve the desired effects, but if it is possible to treat the problem internally, results may be better and more effective by being able to directly treat and change the body. In order to achieve the balanced and normal biological frequency in the body as explained previously, the methodology of the photodynamic energized water utilizes a light emitter consisting of light from multiple spectrums and capable of emitting multiple frequencies that, once absorbed by the drinking water, will produce resonant frequencies. By controlling the wavelength of light emitted as well as the amount of time emitted on the water, one can control for the desired wavelength absorbed by the water.

Thus, once the photodynamic energized water is consumed by the body and absorbed by organs at the same frequency, its constructive/destructive effects aids the body's energy balance and cellular activity to change one's body type and strengthen one's immunity.

Below is detailed procedural information along with corresponding diagrams to better understand the photodynamic energized water's practical application:

### DETAIL DESCRIPTION OF THE EMBODIMENTS

As seen in FIG. 1, this apparatus mainly comprises a light emitting device 1, and a container 2 below the light emitting device 1. The light emitting device 1 includes multiple light emitters 11 in series. The light emitters 11 are capable of emitting light at various spectrums, such as white, red, yellow, orange, green, violet, etc. Each different colored light emitter 11 corresponds to different frequencies, and is emitted into the water inside the container 2 via the light emitting device.

Also, the light emitting device 1 described above can use LED, LD, Laser or other device which is able to produce light at the desired frequency whether through a lens or another method in order to control the frequency. In addition, the container 2 could be a normal cup or other pre-setup appliance, which is able to hold drinking water. The container 2 can either manually or automatically control the water level as well as amount of time the water is exposed to the light emitter 11 to cooperate with the different frequencies being emitted.

Therefore, once the water inside the container 2 has been exposed to the light emitter 11 and has absorbed the photon frequency, the water molecules will conform to the desired frequency compatible with that needed by the body. Once this water is consumed and absorbed by the body, it has the ability of mediating the biological frequency of various organ systems and aiding in the normal functioning of body cells. Also, constructive interference can increase energy or accelerate energy conversion within the body which aids in growth, activity, maintaining body temperature, and other necessary body functions. Thus, if the body's biological frequency can be constructively controlled, the natural bodily reactions may be resulted in first effect of the “Thermal regulation”, which is the constructive biological frequency—due to increased energy or rapid energy conversion, molecular cell excitation increases thus raising the body temperature and dilating blood vessels to aid in circulation and metabolism, increased function of organ systems, for example, the digestive and gastrointestinal function, nutrient absorption and waste reduction, liver, lungs, and various other systems; second effect of the “Increased Cellular Activity”, 70% of the human body is made up of water and is responsible for the chemistry and physics of organ system functions, circulation, and cell membrane permeability for effective transport, the changing temperatures of the body are responsible for the conversion of water between its gas, liquid and solid states by affecting the intermolecular forces in water molecules and the rise of body temperature can cause large water molecules to split into smaller water molecules and allow for easier transportation and permeability between organ systems resulting in heightened activity, thus, constructive biological frequency has the ability of increasing energy in the body, producing heat effects and increasing cellular activity within the body; and third effect of the “Nervous System Activation”, the nervous system is made up of nerves that extends to all parts of the body, and when biological frequency increases, the nervous system function becomes more effective thus activating the various organ systems to aid in pains of the shoulder, back, limbs, stress, insomnia, etc.

Thus, self resonant biological frequency has energy producing capabilities, is economical, and is not restricted by time or space. The resonance helps to increase energy or frequency transmission which results in improved thermal regulation, cellular activity, nervous system activity, circulation, metabolism, immunity, and general health to positively affect bodily imbalance caused by disease.

The above-mentioned preferred embodiments of the present invention are not intended to limit the scope of the present invention. Modifications and changes may be made in various embodiments of the present invention without leaving the scope and spirit of the present invention. The scope of the present invention is limited only by the language of the following claims.

Other features and advantages of the invention will become apparent from the following detailed description, taken in conjunction with the accompanying drawings.

### DESCRIPTION OF THE DRAWINGS

FIG. 1 is a schematic view of the present invention.

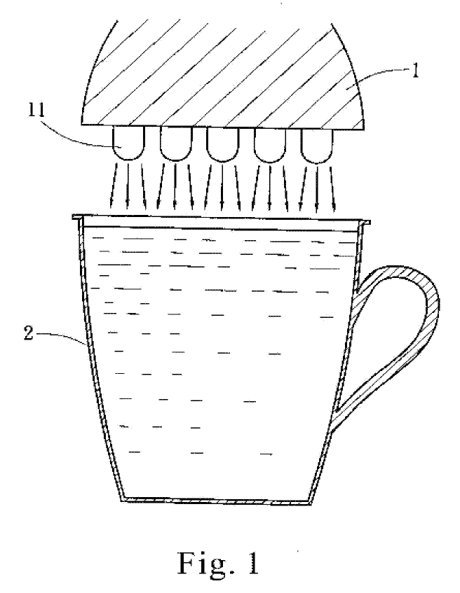

What is claimed is:

1. An apparatus for photodynamic energized water, said apparatus comprising: a light emitting device with multiple light emitters of producing light from various spectrums and wavelengths to be absorbed by water.

2. The apparatus set forth in claim 1, wherein the light emitters are capable of producing light of white, red, yellow, orange, green, indigo, purple, and blue spectrum or the combination of any of the aforementioned colors.

3. The apparatus set forth in claim 1, wherein the light emitters can emit light of LED, LD, or Laser, etc.

4. The apparatus set forth in claim 1, wherein the light emitters are fully controllable regarding amount of time light is emitted and frequency of light emitted, which is in order to create a desired frequency to be absorbed by the water.
